(19) United States
(12) Patent Application Publication
(10) Pub. No.: US 2014/0355307 A1
(43) Pub. Date: Dec. 4, 2014

(54) DISPLAY APPARATUS

(71) Applicant: InnoLux Corporation, Miao-Li County (TW)

(72) Inventors: Wen-Jyh SAH, Miao-Li County (TW); Chun-Yi KUO, Miao-Li County (TW)

(73) Assignee: InnoLux Corporation, Miao-Li County (TW)

(21) Appl. No.: 14/287,621

(22) Filed: May 27, 2014

(30) Foreign Application Priority Data
May 30, 2013 (TW) 102119058

(51) Int. Cl. G02F 1/1335; B60Q 3/04; F21V 8/00

(52) U.S. Cl. CPC G02F 1/133602; G02F 1/133603; G02B 6/0068; B60Q 3/044
USPC 362/613; 362/97.1

(57) ABSTRACT

A display apparatus is provided, including a panel module and a light module. The panel module has a display surface. The light module is disposed on a side of the panel module and has a main light source and an auxiliary light source. The main light source emits a first light to the display surface to produce an image. The auxiliary light source emits a second light to the display surface to increase the brightness of at least one first region of the image.

### CROSS REFERENCE TO RELATED APPLICATIONS

The present application claims priority of Taiwan Patent Application No. 102119058, filed on May 30, 2013, the entirety of which is incorporated by reference herein.

### BACKGROUND OF THE INVENTION

1. Field of the Invention

The present application relates to a display apparatus, and in particular, relates to a display apparatus having an auxiliary light source.

2. Description of the Related Art

Liquid crystal displays (LCDs) have been widely applied in various electronic products. For automotive display, mechanical instrument panel has mostly been replaced by LCD device.

However, as the automotive LCD device is easily affected by sunlight, the contrast and saturation of images therein may decrease, such that drivers may ignore warning signals or driving assistance indicator lights of the instrument panel.

BRIEF SUMMARY OF THE INVENTION

In view of the aforesaid problems, an embodiment of the invention provides a display apparatus including a panel module and a light module. The panel module has a display surface. The light module is disposed on a side of the panel module and has a main light source and an auxiliary light source. The main light source emits a first light to the display surface to produce an image. The auxiliary light source emits a second light to the display surface to increase the brightness of at least one first region of the image.

### BRIEF DESCRIPTION OF THE DRAWINGS

The invention can be more fully understood by reading the subsequent detailed description and examples with references made to the accompanying drawings, wherein:

FIG. 1 is a schematic view of a display apparatus according to an embodiment of the invention;

FIG. 2 is a schematic view of a display apparatus according to another embodiment of the invention;

FIG. 3 is a schematic view of a display apparatus according to yet another embodiment of the invention.

### DETAILED DESCRIPTION OF THE INVENTION

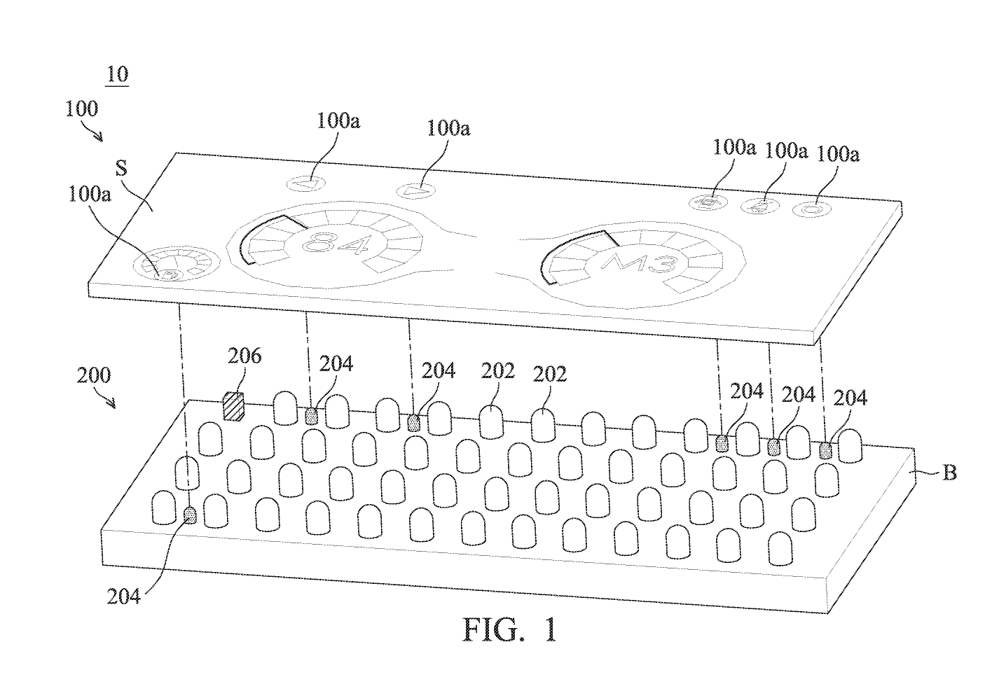

Referring to FIG. 1, a display apparatus 10 of an embodiment of the invention may be an automotive display, such as an instrument panel. The display apparatus 10 primarily includes a panel module 100 and a light module 200.

As shown in FIG. 1, the light module 200 is a direct-type backlight module disposed on a bottom side of the panel module 100. Namely, the panel module 100 is situated between the driver and the light module 200. The light module 200 primarily includes a substrate B, a plurality of main light sources 202 and auxiliary light sources 204. The plurality of main light sources 202 may be white Light Emitting Diodes (LEDs), white cathode-ray tubes, or other white light sources, arranged in a matrix on the substrate B. In addition, the plurality of main light sources 202 can be controlled by a driving unit to emit a first light (white light) to a display surface S of the panel module 100 for producing an image.

In this embodiment, white, red, green, blue, or other colors are defined and classified as in the Munsell Color System. In the CIE 1931 color space chromaticity diagram, the chromaticity values x=0.31˜0.35 and y=0.31˜0.36, close to the chromaticity values of the standard illuminant C, D50, D55, D65, D75 or B, indicate the “white light”. The dominant wavelength of “red” is between 550 nm and 700 nm (including the 564 nm peak wavelength absorbed by the red cone). The dominant wavelength of “green” is between 500 nm and 600 nm (including the 534 nm peak wavelength absorbed by the green cone). The dominant wavelength of “blue” is between 380 nm and 500 nm (including the 400 nm peak wavelength absorbed by the blue cone). “Color” in the description below may indicate any color distinguished from white. It is noted that the first light emitted from the plurality of main light sources 202 may also be a colored light depending on application and produced by white light sources, colored light sources, or a combination thereof.

The panel module 100 is a liquid crystal panel module including a thin film transistor (TFT) substrate, a color filter substrate, a liquid crystal layer, driving circuits, and related optical components (not shown in FIG. 1). By adjusting the luminous flux of the liquid crystal layer and applying the color filter substrate, a colored image can be shown on the display surface S. As shown in FIG. 1, the image includes at least one first region 100a (warning region) for showing indicator symbols, such as three warning symbols at the right-top corner of the display surface S, two direction symbols in the middle of the display surface S, and a fuel tank symbol at the left-bottom corner of the display surface S. The first regions 100a are usually disposed in predetermined positions and have different colors from the other regions of the image so as to enhance the warning efficiency for the drivers. The areas of the first regions 100a are smaller than that of the display surface S, as well as the area of the entire image shown on the display surface S.

In this embodiment, a control unit 206 and the auxiliary light sources 204 are disposed on the substrate B. The control unit 206 is electrically connected to the auxiliary light sources 204 for driving the auxiliary light sources 204 to individually emit a second light to the corresponding first regions 100a, so as to increase the brightness or change the saturation of the first regions 100a. In some embodiments, the control unit 206 may be combined with the driving unit of the main light source 202 to individually or simultaneously drive the plurality of main light sources 202 or the auxiliary light sources 204. The auxiliary light sources 204 may be red light sources (LEDs or CCFLs), blue light sources (LEDs or CCFLs), green light sources (LEDs or CCFLs), white light sources (LEDs or CCFLs), other colored light sources, or a combination thereof depending on the predetermined colors (white or color) of the first regions 100a. The brightness and saturation of the auxiliary light sources 204 can be adjusted to clearly show the warning symbols. The area on the display surface S where the first light is projected exceeds that of on the display surface S where the second light is projected.

The auxiliary light sources 204 are disposed corresponding to the first regions 100a (FIG. 1). When the control unit 206 drives a specific auxiliary light source 204 to light, the brightness of the corresponding first region 100a can be increased to exceed the average brightness of the image on the display surface S by at least 50 to 500 nits. Accordingly, the saturation of the corresponding first region 100a can also be increased to reduce interference from the sunlight, so that the warning symbols can be noticed by the drivers easily.

In some embodiments, the control unit 206 may drive the auxiliary light sources 204 to flicker to catch the attention of divers. In some embodiments, when the auxiliary light sources 204 emit the second lights to the first regions 100a, the transmittance of some specific areas in the panel module 100 corresponding to the first regions 100a can be increased, or the transmittance of the other areas near to the first regions 100a can be reduced. Thus, the brightness and saturation of the first regions 100a can be enhanced to contrast with the other regions of the image.

In some embodiments, the main light source 202 may also be an R/G/B LED which produces white light or colored light by mixing three color lights. The auxiliary light source 204 may also be an R/G/B LED in which a single chip can be driven to selectively produce red, green, or blue light. The invention does not limit the color of the auxiliary light sources 204 as long as that can match with the predetermined color of the first regions 100a. The quantity and type (such as light bulb or tube) of the main light source 202 and the auxiliary light source 204 are also not limited to that in FIG. 1.

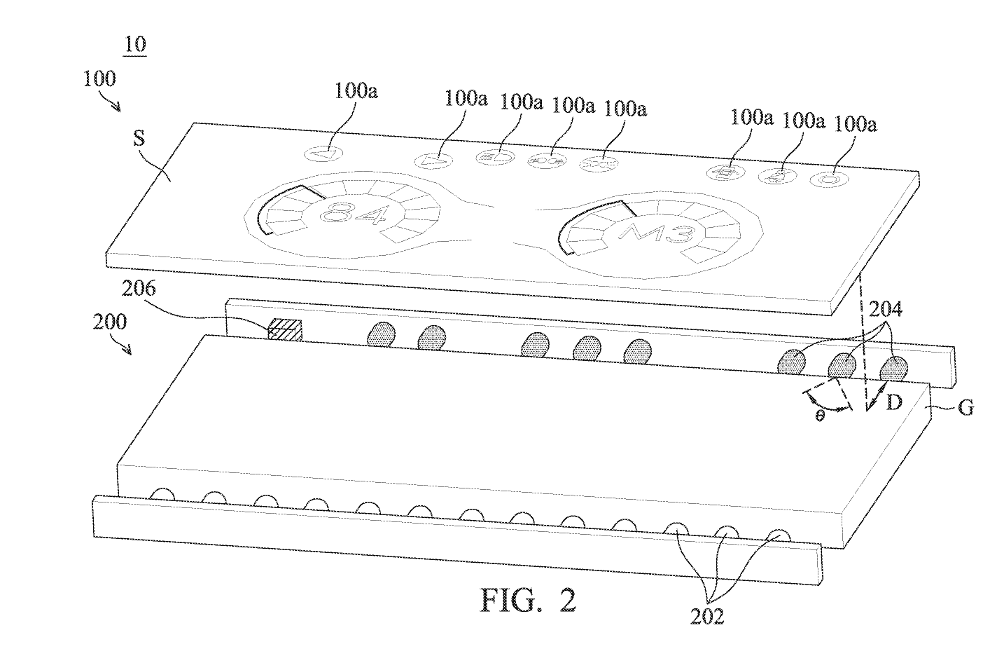

FIG. 2 is a schematic view of a display apparatus according to another embodiment of the invention. The difference between the display apparatus 10 in this embodiment and the embodiment of FIG. 1 is that the light module 200 is an edge-type light module. The direction of the light entering a light guide plate G of the light module 200 is substantially perpendicular to a normal direction of the panel module 100, wherein the plurality of main light sources 202 and the auxiliary light sources 204 are disposed on opposite sides of the light guide plate G.

Note that, the lights emitted from the auxiliary light sources 204 are guided by the light guide plate G to the display surface S of the panel module 100, thus increasing the brightness of the first regions 100a. In this embodiment, the auxiliary light sources 204 and the corresponding first regions 100a are disposed near a side of the light guide plate G (FIG. 2), so as to prevent the lights from the auxiliary light sources 204 from interfering with other regions of the image on the display surface S.

In some embodiments, the main light sources 202 and the auxiliary light sources 204 can be disposed on the same side of the light guide plate G. In some embodiments, more main light sources 202 or auxiliary light sources 204 can be added to the left and right sides of the light guide plate G, and the first regions 100a can be disposed on the left and right sides of the display surface S, corresponding to the auxiliary light sources 204.

In some embodiments, the bottom side of the light guide plate G may further include a plurality of light guide structures, such as prisms having V-shaped cross-sections or optics having semicircular cross-sections, corresponding to the auxiliary light sources 204. The light guide structures can guide the second lights to the display surface S precisely and increase the brightness of the first regions 100a of the image. The propagating distance of the second light inside of the light guide plate G is indicated as D (FIG. 2), which depends on the positions of the light guide structures and the first regions 100a. The beam angle θ of the auxiliary light sources 204 is in the range of 1 degree to 180 degrees.

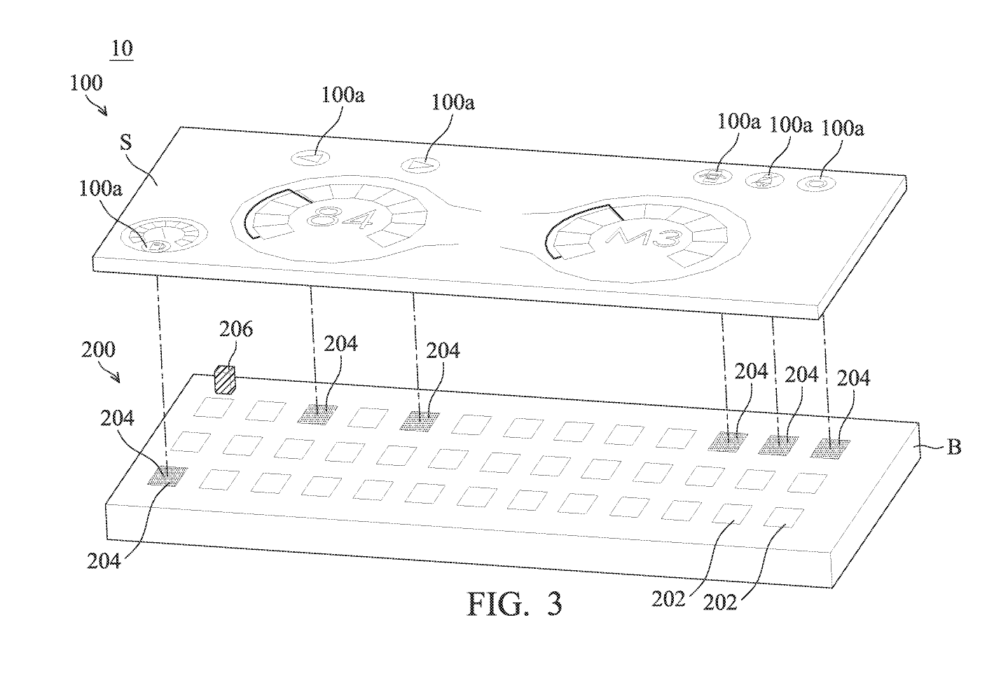

Referring to FIG. 3, the light module 200 can also be an active matrix Organic Light-Emitting Diode (OLED) panel, which includes a substrate, a driving unit, circuits, (white, red, green, blue, or other colors) OLED matrix, and a package. The OLED matrix includes a plurality of main light sources 202 and auxiliary light sources 204 which emit lights to the display surface S of the panel module 100 for producing an image having a plurality of first regions 100a. In some embodiments, the panel module 100 can be a liquid crystal panel, a transparent substrate (cover glass), or a transparent substrate (cover glass) having color filters. For the related structure and design of this embodiment, reference can be made to the aforementioned embodiments, wherein the auxiliary light sources 204 can increase the brightness or adjust the saturation of the specific first regions 100a.

The display apparatus 10 may also be an industrial display, so that an image having noticeable warning or operation symbols can be shown on the industrial display.

As mentioned above, the invention provides a display apparatus such as an automotive or industrial display, including a panel module and a light module. The main light source of the light module can produce an image on a display surface of the panel module. The auxiliary light source of the light module can increase the brightness of at least one first region of the image. According to the aforesaid features, the brightness and saturation of the first regions (warning or operation symbols) shown on the automotive or industrial display can be increased to catch the attention of the divers.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display apparatus, comprising:
a panel module, having a display surface; and
a light module, disposed on a side of the panel module, having a main light source and an auxiliary light source, wherein the main light source emits a first light to the display surface to produce an image, and the auxiliary light source emits a second light to the display surface to increase the brightness of at least one first region of the image.

2. The display apparatus as claimed in claim 1, wherein the main light source includes a white LED, a color LED, or a combination thereof

3. The display apparatus as claimed in claim 1, wherein the auxiliary light source includes a white LED, red LED, blue LED, green LED, or a combination thereof.

4. The display apparatus as claimed in claim 1, wherein the light module is a direct-type light module disposed opposite to the panel module and has a substrate, and the auxiliary light source is disposed on the substrate and corresponds to the first region.

5. The display apparatus as claimed in claim 1, wherein the light module is an edge-type light module having a light guide plate, and the main light source and the auxiliary light source are disposed on the peripheral of the light guide plate.

6. The display apparatus as claimed in claim 5, wherein the light guide plate has a light guide structure corresponding to the auxiliary light source for guiding the second light to the first region.

7. The display apparatus as claimed in claim 6, wherein the light guide structure has a V-shaped or semicircular cross-section.

8. The display apparatus as claimed in claim 1, wherein the auxiliary light source emits the second light flickeringly to the first region.

9. The display apparatus as claimed in claim 1, wherein when the auxiliary light source emits the second light to the first region, the brightness of the first region is greater than that of the other regions in the image.

10. The display apparatus as claimed in claim 9, wherein when the auxiliary light source emits the second light to the first region, the brightness of the first region exceeds the average brightness of the image by at least 50 to 500 nits.

11. The display apparatus as claimed in claim 1, wherein the light module further has a control unit for driving the auxiliary light source.

12. The display apparatus as claimed in claim 1, wherein the light module further has an OLED.

13. The display apparatus as claimed in claim 1, wherein the area of the first region is smaller than that of the image.
